(19) United States
(12) Patent Application Publication
(10) Pub. No.: US 2013/0116941 A1
(43) Pub. Date: May 9, 2013

(54) FLUID PIPE MONITORING AND REPORTING SYSTEM

(71) Applicant: Watersignal, LLC, Alpharetta, GA (US)

(72) Inventors: John Lie-Nielsen, Alpharetta, GA (US); Tibor Szenti, Cumming, GA (US)

(73) Assignee: WATERSIGNAL, LLC, Alpharetta, GA (US)

(21) Appl. No.: 13/662,199

(22) Filed: Oct. 26, 2012

Related U.S. Application Data
(60) Provisional application No. 61/555,749, filed on Nov. 4, 2011.

(51) Int. Cl. G01F 1/00; G06F 19/00

(52) U.S. Cl. 702/46

(57) ABSTRACT

Disclosed herein is continuous fluid monitoring and reporting system. The continuous fluid monitoring and reporting system comprises a fluid monitoring subsystem comprising a processing unit configured to receive digital pulses indicative of a set amount of fluid that has flowed through a pipe and to count the digital pulses and store data comprising indications of the counted digital pulses in a memory. The stored data is periodically transmitted to a remote computer using a communication device. The remote computer includes a fluid monitoring engine to analyze the received data and to generate fluid flow information which may be used to generate reports and alerts to authorized users. In some embodiments, the fluid monitoring subsystem includes an intelligent sensor configured to obtain signals indicative of fluid flow at a fluid monitor and to output the digital pulses to the processing unit.

### RELATED APPLICATIONS

This application is based on and claims priority to U.S. Provisional Application No. 61/555,749, filed on Nov. 4, 2011, by John Lie-Nielsen et al., entitled, “INTELLIGENT SENSOR FOR WATER METER,” the contents of which are herein incorporated by reference.

### BACKGROUND

1. Field of the Invention

The present invention relates generally to the monitoring of pipes containing a fluid for flow of the fluid. In particular, it is related to a water pipe leak monitoring and reporting system that can monitor water flow within a pipe at a water meter to detect a potential leak, and send data about the water flow within the pipe to a remote computer for analysis and reporting.

2. Description of the Related Art

Fluid monitors, or flow meters, measure the amount of fluid that flows through a pipe or an open conduit. Various techniques for measuring fluid flow exist and operate on differing principles. For instance, mechanical flow meters (e.g., displacement, turbine, etc.) translate mechanical action into a flow rate of a fluid. By contrast, other techniques may rely on optical, thermal, or even electromagnetic principles to measure a volumetric amount or flow rate of a fluid.

Water meters may use any of the aforementioned techniques to measure the amount of water that flows through a pipe. Water can be measured with water meters for a single-unit residence, a multi-unit residence, a business, a business complex, or any other place or property. Water meters typically include a display that can be read on a periodic basis and used as a basis for billing customers for the amount of water used during a particular time period. In most cases, water meters include registers with coupling magnets that rotate based on the amount of flow through the water meter. These coupling magnets are used by the register to communicate the amount of water flowing through the water meter.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Accordingly, disclosed herein is a system for monitoring fluid flow within a pipe at a fluid monitor. The system comprises a fluid monitoring subsystem including a processing unit configured to receive a plurality of digital pulses indicative of a set amount of fluid that has flowed through the pipe. The processing unit comprises a microcontroller configured to count the plurality of digital pulses, a memory configured to store data, the data comprising indications of each of the counted digital pulses, and a communication device configured to transmit the data to a remote computing device. In some embodiments, the fluid monitoring subsystem includes an intelligent sensor adjacent the fluid monitor and configured to generate signals indicative of the fluid flow within the pipe. The intelligent sensor may comprise a magnetic sensor configured to generate the signals based on sensing a magnetic field created by coupling magnets within the fluid monitor, and a second microcontroller configured to receive the signals and to output the plurality of digital pulses.

In some embodiments, a process for monitoring fluid flow and provisioning alerts comprises receiving data indicative of an amount of fluid that has flowed through a pipe associated with a fluid monitor, storing the received data in a memory, analyzing at least a portion of the received data to generate fluid flow information, the fluid flow information comprising the amount of fluid that has flowed through the pipe at a location of the fluid monitor over a period of time, comparing the fluid flow information to a criterion, generating an alert when the criterion is satisfied, and provisioning the alert to a user. In some embodiments, the process further includes generating a report based at least in part on the fluid flow information, the report including the alert.

By continuously monitoring fluid flow within a pipe at a fluid monitor using the embodiments disclosed herein, data may be analyzed over time to generate fluid flow information. This fluid flow information may reveal defects in the fluid system at a certain location, such as leaks in pipes, pools, internal plumbing, and other components of a fluid system. The fluid monitoring subsystem can be used in conjunction with the fluid monitor without interfering with the fluid monitor itself. The fluid monitoring subsystem is capable of continuous and reliable monitoring of fluid flow such that response times for alert conditions can be shortened. Water systems, in particular, may benefit from improved conservation of water resulting from transparent, real-time reporting of water flow data by the fluid monitoring system.

Other features and advantages of the present invention will become apparent from the following description of the invention, which refers to the accompanying drawings.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example of an architecture of a fluid monitoring system which implements a fluid monitoring service, the architecture comprising a fluid monitoring subsystem comprising an optional intelligent sensor and a processing unit that can continually monitor fluid flow at a fluid monitor and send data about fluid flow to a remote computer(s) for analysis and reporting of the data.

FIG. 2 illustrates a detailed diagram of an example fluid monitoring subsystem comprising an intelligent sensor and a processing unit configured to continuously monitor fluid flow at a fluid monitor.

FIG. 3 illustrates an example of a screen rendering of an interactive dashboard user interface for reporting fluid flow information to an authorized user.

FIG. 4 illustrates an example of a screen rendering of an alerts page comprising a list of alerts associated with fluid monitors for presentation to an authorized user.

FIG. 5 illustrates an example of a screen rendering of an interactive reports page for reporting fluid flow information to an authorized user.

FIG. 6 is a flow diagram of an illustrative process for continuously monitoring fluid flow at a fluid monitor and sending data pertaining to the monitored fluid flow to a remote computer for analysis and reporting.

FIG. 7 is a flow diagram of an illustrative process for receiving data pertaining to fluid flow from a continuous fluid monitoring subsystem, analyzing the received data to generate fluid flow information, and generating reports, and alerts when necessary, based on the fluid flow information.

### DETAILED DESCRIPTION

Embodiments of the present disclosure are directed to, among other things, techniques and systems for continuously monitoring fluid flow at a fluid monitor, or flow meter, and sending data about fluid flow to a remote computer for analysis and reporting.

### Example Architecture

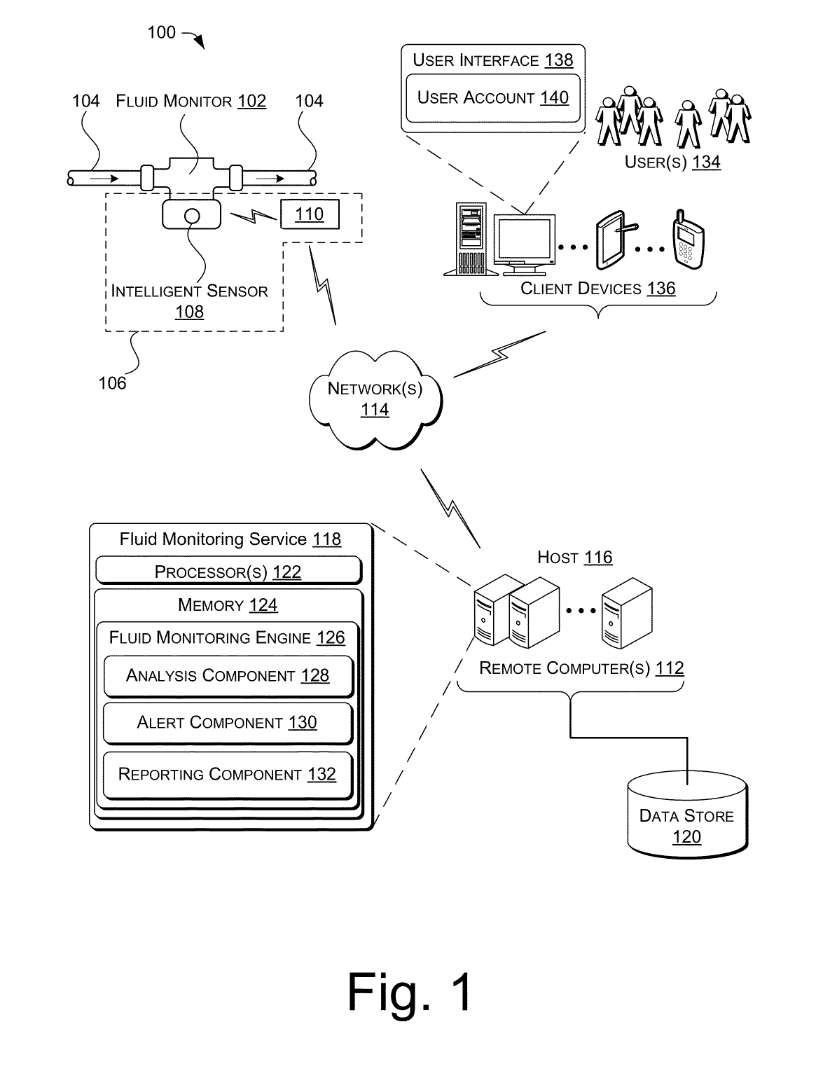

FIG. 1 illustrates an example of an architecture 100 of a fluid monitoring system for implementing a real-time fluid monitoring service. In the architecture 100, a fluid monitor 102, or flow meter, is configured to measure the amount of fluid that passes through a pipe 104. As used herein, the term “fluid” may comprise any substance that is capable of flowing, and that changes its shape when acted upon by a force. Fluids may include, but are not limited to, liquids, gases, plasmas or plastic solids such as water, sewage, nuclear waste, oil, molten metal, and the like. As shown in FIG. 1, fluid moves from left to right inside of the pipe 104. In some embodiments, the fluid monitor 102 may be a water meter and may include coupling magnets which rotate based on the amount of water that passes through the pipe 104. Each rotation of the coupling magnets represents a set amount of water that passes through the pipe 104. A fluid monitoring subsystem 106 may comprise an intelligent sensor 108 adjacent the fluid monitor 102. For example, as shown in FIG. 1, the intelligent sensor 108 may be attached to the outside of the fluid monitor 102. Alternatively, the intelligent sensor 108 may be separate, but adjacent, the fluid monitor 102. The intelligent sensor 108 is magnetically coupled to the fluid monitor 102 in order to interact with the fluid monitor 102. For example, the intelligent sensor 108 may be configured to sense movement of the coupling magnets within the fluid monitor 102 in order to determine fluid flow and to generate signals indicative of fluid flow.

The fluid monitoring subsystem 106 comprises a processing unit 110 configured to receive digital signals, or pulses, relating to an amount of fluid that passes through the pipe 104. The digital pulses may be received, in some embodiments, directly, or indirectly, from the fluid monitor 102 when the fluid monitor 102 is configured to output signals indicative of fluid flow through the pipe 104. In this scenario, there is no need for the intelligent sensor 108, as the pulses may be sent to the processing unit 110 via a physical communication line(s), such as a cable. The fluid monitor 102, in this case, may comprise a reed switch that is activated by a moving magnet providing on and off “dry” contacts. Alternatively, the pulse may be electronically generated through an output transistor in the fluid monitor 102. In yet other embodiments, the intelligent sensor 108 may be included in the fluid monitoring subsystem 106, the intelligent sensor 108 being connected to the processing unit 110 via a physical communication line(s), such as a cable, which allows the digital pulses to be passed between the intelligent sensor 108 and the processing unit 110. In some embodiments, the physical communication line(s) may also include power lines configured to provide power to the intelligent sensor 108 from a power source, such as a battery within the processing unit 110. In some embodiments, the physical communication line may be a shielded cable. The processing unit 110 may receive the digital signals sent from either the fluid monitor 102 or the intelligent sensor 108, and may be located in a meter box, such as an underground meter box, where the fluid monitor 102 and the intelligent sensor 108 may be located.

The processing unit 110 may include a communication device, such as a cell modem, which can communicate data to one or more remote computers 112, or servers, over a network(s) 114. The remote computer(s) 112 may be owned, or controlled, by a host 116. The remote computer(s) 112 may be arranged in a cluster or as a server farm, and may host a website or another type of information server. The website can be any type of website that supports user interaction, including private (i.e., Intranet) websites, or public websites including online retailers, e-commerce sites, informational sites, social networking sites, social commerce sites, blog sites, search engine sites, news and entertainment sites, and so forth. Other server architectures may also be used to host the website. The network(s) 114 represents any one or combination of multiple different types of networks, such as wide area networks (WANs) or local area networks (LANs) and including cable networks, the Internet, wireless networks. In the illustrative environment, the website represents a service provider website that provides a fluid monitoring service 118, and hosts a website with information relating to fluid flow whereby authorized users may access the website and consume information pertaining to the fluid flow.

The remote computer(s) 112 may receive the data from the processing unit 110 via the network(s) 114, which may be sent according to a predetermined schedule, such as once per day. Alternatively, the processing unit 110 may count the digital pulses, and may send data to the remote computer(s) 112 when the digital pulse count exceeds a threshold level. It is to be appreciated that the processing unit 110 may also be configured to receive information from the remote computer(s) 112, such as when the remote computer(s) 112 sends updates to operating parameters of the processing unit 110. For example, the remote computer(s) 112 may send updates to the predetermined schedule for transmitting data to the remote computer(s) 112.

The data that is received by the remote computer(s) 112 from the processing unit 110 may be stored in a data store 120. As will be described in detail below, the data stored in the data store 120 may be accessed, either directly, or indirectly, by applications which may further process the accessed data in order to generate information in a format usable by an authorized user. In some embodiments, and in particular for embodiments pertaining to water systems and monitoring water usage, the data store 120 may further include other types of data relating to properties (i.e., buildings, apartments, houses, etc.), including management company information for the properties, occupancy data of the properties, geographic data of the properties, number of units, and data relating to water bills and rates for various properties in various locations.

As illustrated in FIG. 1, the remote computer(s) 112 comprise one or more processors 122 and one or more forms of computer-readable memory 124. The memory 124 may comprise volatile and nonvolatile memory. Thus, the memory 124 may include, but is not limited to, random access memory (RAM), read-only memory (ROM), erasable programmable read-only memory (EEPROM), flash memory, or other memory technology, or any other medium which can be used to store applications and data. The memory 124 may also include removable media such as optical storage media, including optical disks, or magnetic cassettes, magnetic tape, magnetic disk storage or other magnetic storage devices, redundant array of independent disks (RAID) storage systems, portable devices/drives, and so forth. The memory 124 may be used to store any number of functional, or executable, components, such as programs and program modules that are executable on the processor(s) 122 to be run as software. Each component stored in the memory 124 may comprise computer-executable instructions that, when executed, cause the one or more processors 122 to perform acts and to implement techniques described herein. Each component may be in the form of data structures, program modules, or other data.

The remote computer(s) 112 may include the fluid monitoring service 118 which utilizes a fluid monitoring engine 126 for analysis and reporting of information related to fluid flow. It is to be appreciated that the fluid monitoring service 118 may be implemented and maintained by the host 116, or it may optionally be sold to third parties, such as property owners who may purchase, or otherwise pay for access to, the fluid monitoring service 118. Accordingly, the fluid monitoring service 118 may be internal, or external, to the architecture 100. The fluid monitoring engine 126 includes an analysis component 128 configured to access, directly or indirectly, the data within the data store 120 and to analyze, or further process, the accessed data to generate information relating to fluid flow at one or more fluid monitors, such as the fluid monitor 102. The information generated by the analysis component 128 may include, but is not limited to, an amount, or average amount, of fluid that has flowed through a pipe over a given time period at particular intervals of the time period, an estimated annualized cost in terms of energy or money, etc. In embodiments pertaining to water systems, the information may include an amount of water used per property unit for a given time period, an estimated annualized cost of water based on analysis of water bills, an estimated annual cost per property unit based on analysis of water bills, etc. For example, the information may include gallons of water used per unit per day, or the average gallons of water used per hour, and similar information that may be useful to an authorized user.

The information generated by the analysis component 128 may be used by the fluid monitoring engine 126 to determine whether fluid flow is abnormal such that it should be reported via an alert, or warning indicator, to appropriate authorized users. For instance, the generated information may include one or more alerts that ultimately reveal defects in the fluid system at a certain location, such as leaks in pipes, pools, internal plumbing, and other components of a system. Accordingly, the fluid monitoring engine 126 may further include an alert component 130 which is configured to receive, or otherwise access, the information generated by the analysis component 128 and to apply criteria and/or thresholds, or limits, to the generated information in order to determine whether alert conditions are met. That is, the alert component 130 may include predetermined alert settings associated with one or more fluid monitors, such as the fluid monitor 102, which comprise one or more threshold levels of amounts of fluid flowing over a given time period. Thus, if the information generated by the analysis component 128 indicates that fluid flow at the fluid monitor 102 meets or exceeds the threshold level according to predetermined alert settings associated with the fluid monitor 102, an alert condition (sometimes referred to herein as a trigger event) is satisfied such that the alert component 130 provisions an alert to one or more authorized users associated with the fluid monitor 102. For example, a threshold for a particular fluid monitor 102, such as a water meter, may be set at 1,000 gallons per hour for all times of the day. If monitoring via the fluid monitoring subsystem 106 indicates that water usage over the last hour reached 1,140 gallons, a trigger event occurs where an alert is provisioned indicating that the threshold of 1,000 gallons has been exceeded in the last hour.

In some embodiments, and in particular for water systems, other factors may be considered for the alert settings, such as whether an occupancy level of a property is below a certain threshold. For example, an alert condition may be met at a lower threshold water usage if the occupancy of the property is below a certain percentage (e.g., below 75% occupancy). In other words, the threshold level of water usage may vary according to the occupancy level of a given property.

It is to be appreciated that an alert may be provisioned by the alert component 130 in any suitable manner known to a person having ordinary skill in the art, and may include sending an email, a short message service (SMS) text message, social networking message, and the like. Alerts may also be provisioned by the alert component 130 via a reporting component 132 which is also included within the fluid monitoring engine 126. In this scenario, an alert may be provisioned via a user interface associated with an application or web browser for accessing the website of the host 116.

In some embodiments, scoring algorithms may be utilized by the alert component 130 in order to determine scores for each of a plurality of alerts. The scores may indicate a severity of the alert condition, which may be based at least in part on a degree by which a monitored amount of fluid exceeds the threshold amount of fluid in the predetermined alert settings. For instance, a relatively higher score may be associated with a fluid monitor whose monitored fluid flow exceeds an alert setting by a relatively higher amount to that of another fluid monitor's fluid flow. These scores may be used to rank the alerts relative to each other. Consequently, an authorized user who is interested in the alerts from a given fluid monitor may be able to address the alerts in order of priority, which may be particularly useful when a large number of alerts are generated for one or more fluid monitors. The output of the alert component 130 is a list (optionally ranked) of one or more alerts for consumption by authorized users.

The fluid monitoring engine 126 further includes the reporting component 132. The reporting component 132 is configured to access the information generated by the analysis component 128, and, when necessary, the alerts generated by the alert component 130, in order to generate reports based on the accessed information and alerts. For instance, the reporting component 132 may generate monthly reports on fluid flow (e.g., water usage), or other breakdowns of fluid flow over a given time period. The reporting component 132 may present, display, or otherwise communicate the reports, including alerts when applicable, to authorized users 134. The reporting component 132 may present information relating to fluid flow via a graphical user interface (GUI). In general, the GUI is an interactive user interface that is configured to enable interaction with various reporting data offered by the reporting component 132. The GUI may further include a back-end filter(s) and/or management tool(s) to enable an authorized user 134 to manage, or customize, their own reports or information relating to fluid flow. In some embodiments, the reporting component 132 may generate and send an email, or other similar message, such as an SMS text message, or social networking message, to notify the authorized users 134 of fluid flow information and/or alerts relating to fluid flow.

The authorized users 134 may be individuals, organizations, or any other suitable entity. In one illustrative example, the authorized users 134 access the fluid monitoring service 118 via the website of the host 116 over the network 114. The authorized users 134 may utilize client computing devices 136 to access the website, or any other website, via the network 114. The client computing devices 136 may be implemented as any number of computing devices, including a personal computer, a laptop computer, a portable digital assistant (PDA), a mobile phone, a tablet computer, a set-top box, a game console, and so forth. Each client computing device is equipped with one or more processors and memory to store applications and data, as well as at least one input device, and at least one output device. According to some embodiments, a browser application is stored in the memory and executes on the processor to provide access to the website of the host 116. The browser renders web pages served by the website on an associated display. Although embodiments are described in the context of a web based system, other types of client/server-based communications and associated application logic could be used.

As illustrated, the client devices 136 may be equipped with a user interface (UI) 138 to provide access to a user account 140 residing on, or accessible by, the host 116. For example, the user 134 may communicate with the host 116 via the UI 138 on the client device 136 to interact with the user account 140. In one scenario, the client device 136 sends a request to the remote computer(s) 112. Upon receiving the request, the remote computer(s) 112 return a page (or other communication) to a requesting client device 136, allowing the authorized user 134 to interact with the data provided by the remote computer(s) 112, such as the fluid monitoring service 118. The user account 140 may reside at the host 116 on the remote computer(s) 112. The UI may include dedicated applications implemented using software instructions and stored locally on the client device 136, may be used to interact with the host 116. Further, the client device 136 may use simple text commands, such as SMS text messages to communicate with the host 116. The user account 138 may include information associated with an authorized user 134, such as a user identification (ID), an email address, and/or an alias for the authorized user 134, etc. One or more portions of this information may provide a unique identifier for the user account 140. The user account 140 may provide the authorized user 134 access to a data profile associated with the authorized user 134 which enables the authorized user 134 to access associated fluid flow data. In this sense, the authorized users 134 are “authorized” upon login to their user accounts 140.

### Example of a Fluid Monitoring Subsystem

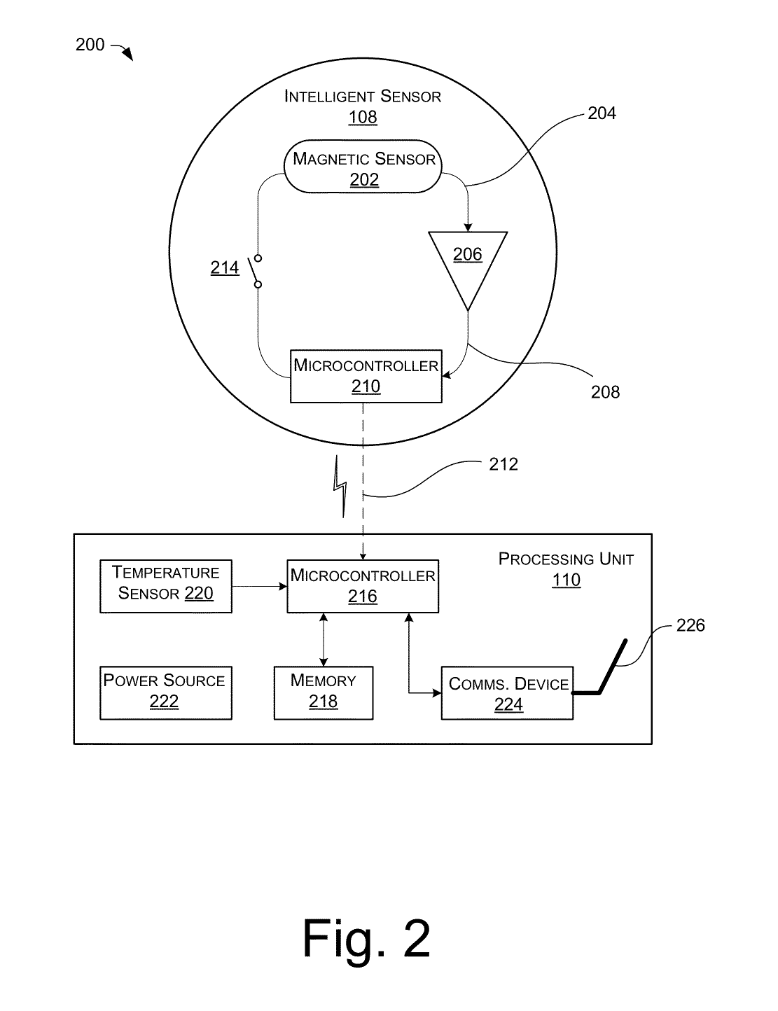

FIG. 2 illustrates an example fluid monitoring subsystem 200 comprising the intelligent sensor 108 and the processing unit 110 shown in FIG. 1. The fluid monitoring subsystem 200 is configured to continually monitor fluid flow through a pipe at a fluid monitor, such as the fluid monitor 102 of FIG. 1, and to send data to the remote computer(s) 112. In some embodiments, the intelligent sensor 108 may comprise a magnetic sensor 202 configured to measure changes in a magnetic field caused by the rotation of coupling magnets in a water meter. The magnetic sensor 202 can be any suitable type of magnetic sensor known to a person having ordinary skill in the art, including hall-effect sensors, or solid-state magnetic sensors, such as silicon-based magnetic sensors that are either anisotropic magnetoresistive (AMR) or giant magnetoresistive (GMR) sensors, etc. The magnetic sensor 202 may be further configured to output an analog signal 204 based on the measurements of the magnetic field. The intelligent sensor 108 may further include an amplifier 206 configured to amplify the analog signal 204 output by the magnetic sensor 202 to generate an amplified analog signal 208.

The intelligent sensor 108 further includes a microcontroller 210 (first microcontroller) which receives the amplified analog signal 208, or a signal from the flow meter 102 indicative of a fluid flow, and sends a digital signal 212, or digital pulse, to the processing unit 110. Accordingly, in the case of receiving the amplified analog signal 208, an analog-to-digital (A/D) converter may be associated with the microcontroller 210 and utilized to convert the amplified analog signal 208 to the digital signal 212. As previously described with reference to FIG. 1, the digital pulses 212 can be sent to the processing unit 110 by a physical communication line(s), such as a cable, and in some cases, the intelligent sensor 108 may be omitted from the fluid monitoring subsystem 200, such as when the fluid monitor 102 is configured to output signals indicative of fluid flow through the pipe 104. In this scenario, the pulses may be sent to the processing unit 110 directly, or indirectly, from the fluid monitor 102. In some embodiments, the physical communication line(s) may also include power lines configured to provide power to the intelligent sensor 108 from a power source within the processing unit 110. Each of the digital pulses 212 may be indicative of a set amount of fluid that has flowed through the pipe 104. In embodiments where the flow monitor 102 includes coupling magnets, each of the digital pulses 212 may represent one rotation of the coupling magnets which corresponds to a set amount of fluid that has flowed through the pipe 104. In some embodiments, the intelligent sensor 108 may further comprise a power switch 214 which is controlled by microcontroller 210 to turn on and turn off the magnetic sensor 202. Accordingly, the microcontroller 210 conserves the amount of power used in the intelligent sensor 108 by turning the magnetic sensor 202 off between measurements of the rotating coupling magnets, possibly turning off the magnetic sensor 202 several times per second.

In some embodiments, the processing unit 110 may comprise a microcontroller 216 (second microcontroller) configured to count a number of received digital pulses 212. The processing unit 110 further comprises one or more memories 218 used to store indications of each digital pulse 212 counted by the microcontroller 216. Each stored indication of a digital pulse 212 may include, or otherwise be associated with, a date and time stamp. The one or more memories 218 may further store an identifier, such as a meter identification (ID), associated with a fluid monitor to which the fluid monitoring subsystem 200 is associated. The meter ID may be associated with the indications of the digital pulses 212 in memory 218 such that it may identify the particular fluid monitor that is associated with the digital pulses 212. The processing unit 110 may further comprise a temperature sensor 220 configured to measure a temperature at each time that a digital pulse 212 is counted by microcontroller 216. Where temperature is measured by temperature sensor 220, each indication of a digital pulse 212 stored in memory 218 can include an indication of the temperature at the time that the digital pulse 212 is counted. The processing unit 110 may further include a power source 222, such as a battery, configured to provide power to the processing unit 110, and/or to the intelligent sensor 108, as previously described. The processing unit 110 further comprises a communication device 224, such as a cellular modem, which can communicate data to a the remote computer(s) 112. The communication device 224 may comprise an antenna 226 for facilitating the transmission of data wirelessly.

The processing unit 110 may be configured to send the data stored in the memory 218 (e.g., the stored indications of each digital pulse 212) to the remote computer(s) 112 via the communication device 224. The data may be sent according to a predetermined schedule, such as once per day, or the data can be sent when the count of the digital pulses 212 exceeds a threshold number of digital pulses 212. Once the data stored in the memory 118 has been sent to the remote computer(s) 112, the sent data may be erased from the memory 218 to make room for data to be collected in the future. In this scenario, the processing unit 110 may wait to receive a confirmation that the sent data has been received at the remote computer(s) 112 before deleting the sent data. The processing unit 110 can also receive information from the remote computer(s) 112 via the communication device 224. For example, the remote computer(s) 112 can update the operating parameters of the processing unit 110, such as the predetermined schedule for transmitting data to the remote computer(s) 112, by sending instructions to the processing unit 110 via the communication device 224.

### Example User Interface

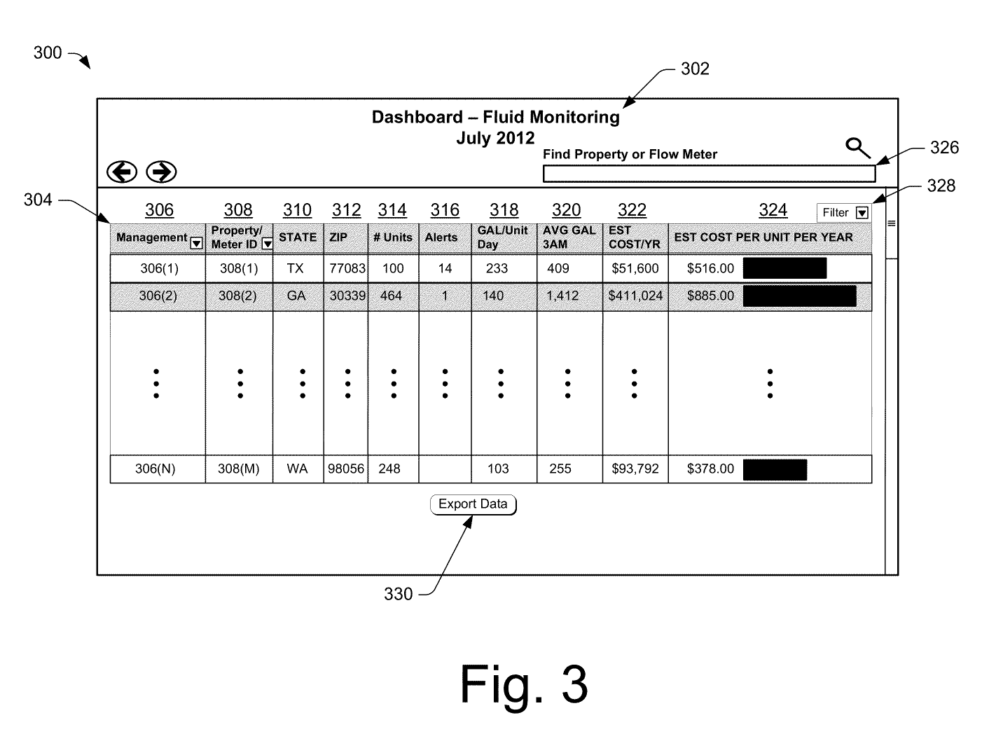

FIG. 3 illustrates an example of a screen rendering of a dashboard user interface 300 associated with an authorized user 134 where information relating to fluid flow is presented to the authorized user 134. In some embodiments, the dashboard user interface 300 may be a Web browser or other browser that can format text based on hypertext markup language (HTML) code. The dashboard user interface 300 may be stored and executed locally on a device (e.g., client devices 136), or remotely by a server such as an online application over a network (e.g., network(s) 114). The reporting component 132 may generate the dashboard user interface 300 for presentation to the authorized user 134, and may be based on information generated by the analysis component 128.

The dashboard user interface 300 includes a message pane 302 with identification text or other informative text relating to the fluid monitoring service 118 and to the time period over which the monitored fluid flow data was obtained. The dashboard user interface 300 may include a fluid flow table 304 which may be used to communicate fluid flow information associated with one or more properties, fluid monitors, and/or authorized users 134. The fluid flow table 304 may include management column 306 for identifying management company/personnel 306(1)-306(N) of a particular property or fluid monitor, a property/meter identification (ID) column 308 for identifying the property, or fluid monitor, 308(1)-(M) associated with the manager in column 306, a state column 310 which indicates the state in which the property/fluid monitor 308(1)-(M) is located, and a zip code column 312. In some embodiments, a number of units column 314 is included indicating the number of units in the case of an associated property 308(1)-(M). The fluid flow table 304 further includes an alerts column 316 indicating the number of alerts output by the alert component 130 during a period, a first fluid flow column 318 indicating the fluid flow for the property/flow monitor 308(1)-(M), a second fluid flow column 320 indicating the average fluid flow at 3:00 AM for the property/fluid monitor 308(1)-(M), a first cost column 322 indicating the estimated annualized cost of fluid based on an analysis of rates or bills available to the host 116, and second cost column 324 indicating an estimated annualized cost per unit of the property. The dashboard user interface 300 may further include a search box 326 for inputting search terms to find a particular property/fluid monitor 308(1)-(M), and may also include a filter tool 328 to filter the fluid flow table 304 by various criteria relating to the information in columns 306-324. For example, in the case of water systems, the authorized user 134 may filter by ranges of gallons per unit per day in column 318 to see only certain properties 308(1)-(M) within a selected range of water usage on a per unit/per day basis. The dashboard user interface 300 may further comprise an export button 330 that, upon selection by the authorized user 134 via a mouse click, touch screen input, or other similar input method, exports the information in the fluid flow table 304 to a file, such as an Excel® file, or a PDF® file, for use by the authorized user 134.

In one illustrative example, an authorized user 134 may access the fluid monitoring service 118 via the website of the host 116, and by utilizing the dashboard user interface 300, the authorized user 134 may view fluid flow data, such as water usage data, relating to properties 308(1)-(M) that may be of interest to the authorized user 134. Importantly, the authorized user 134 may view alerts in the alerts column 316 to be informed of the number of alerts that were triggered for a given property 308(1)-(M). For example, as shown in FIG. 3, upon viewing the fluid flow information in the fluid flow table 304, the authorized user 134 may observe that property 308(1) has 14 alerts that have been generated for the period of July 2012. The authorized user 134 may desire to find out more information about the alerts for a particular property, such as property 308(1). Accordingly, the authorized user 134 may select the number in column 316 for property 308(1) to be directed to a detailed page listing the alerts for the property 308(1).

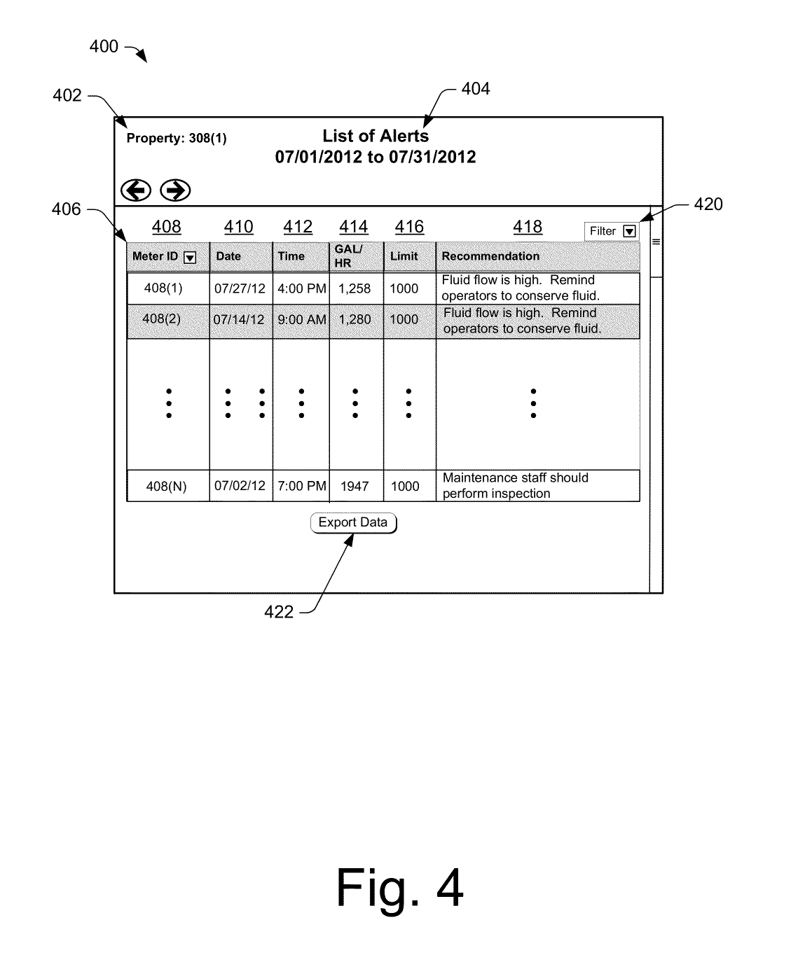

Referring now to FIG. 4, an example of a screen rendering of an alerts page 400 is illustrated which includes a list of alerts associated with one or more flow monitors. In embodiments where there is an associated property, the property may be indicated in message pane 402 of the alerts page 400. In some embodiments, the alerts page 400 may be a page that the authorized user 134 was directed to upon selecting the number of alerts in column 316. Similar to the dashboard user interface 300 shown in FIG. 3, the alerts page 400 is an interactive user interface for the authorized user 134. The alerts page 400 further includes a message pane 404 with identification text or other informative text relating to the alerts and the time period over which the alerts were generated. The alerts page 400 may contain an alerts table 406 which may be used to communicate a list of alerts associated with one or more fluid monitors to the authorized user 134. The alerts table 406 may include a meter identification (ID) column 408 indicating a fluid monitor (flow meter) ID 408(1)-(N), a date column 410 including a date that the alert condition was triggered, a time column 412 including a time of day that the alert condition was triggered, a fluid flow column 414 indicating a measured amount of fluid for the date and time indicated in columns 410 and 412, respectively, a limit column 416 indicating a threshold level of fluid over a time period that triggers an alert condition upon exceeding the limit, and a recommendations column 418 including a recommendation for the authorized user 134 to consider in responding to a particular alert condition. A recommendation in column 418 may be chosen from a list of possible recommendations according to the indicated fluid flow in column 414 relative to the limit indicated in column 416. For example, fluid flow exceeding a limit by a higher amount, such as meter 408(N), relative to other meters in the alerts table 406, may result in a more urgent or directive recommendation. In the case of meter 408(N), the fluid flow exceeds the limit of 1000 gallons per hour by more than the other meters, and as a consequence, a recommendation for maintenance staff to perform an inspection is issued. In contrast to the recommendations issued for the other meters shown in the alerts table 406, this is a more urgent, or directive, recommendation. The alerts page 400 may further include a filter tool 420 to filter the alerts table 406 by various criteria relating to the information in columns 408-418, similar to the filter tool 328 of FIG. 3. The alerts page 400 may further comprise an export button 422 that, upon selection by the authorized user 134 via a mouse click, touch screen input, or other similar input method, exports the information in the alerts table 406 to a file, such as an Excel® file, or a PDF® file, for use by the authorized user 134.

In an illustrative example, as shown in FIG. 4, the fluid being monitored may be water, and a flow meter with meter ID 408(N) is showing that 1,947 gallons of water were used in the hour leading up to 7:00 PM on Jul. 2, 2012. In this example, this level of water usage exceeds a threshold level that was set in the predetermined alert settings at 1,000 gallons per hour, and accordingly, an alert condition was triggered in response to the water usage monitored at 7:00 PM on that date. An authorized user 134 may initially view the dashboard user interface 300 of FIG. 3 to observe that property 308(1) has 14 alerts for the July monthly period. Upon clicking on the number of alerts in column 316 for property 308(1), or otherwise, the authorized user 134 may then be made aware that one of the 14 alerts for property 308(1) is for meter ID 408(N) where water usage exceeds a threshold limit according to predetermined alert settings, and that the fluid monitoring service 118 is recommending that the maintenance staff at the property 308(1) perform an inspection to inspect each fixture and confirm that they are working properly and not leaking.

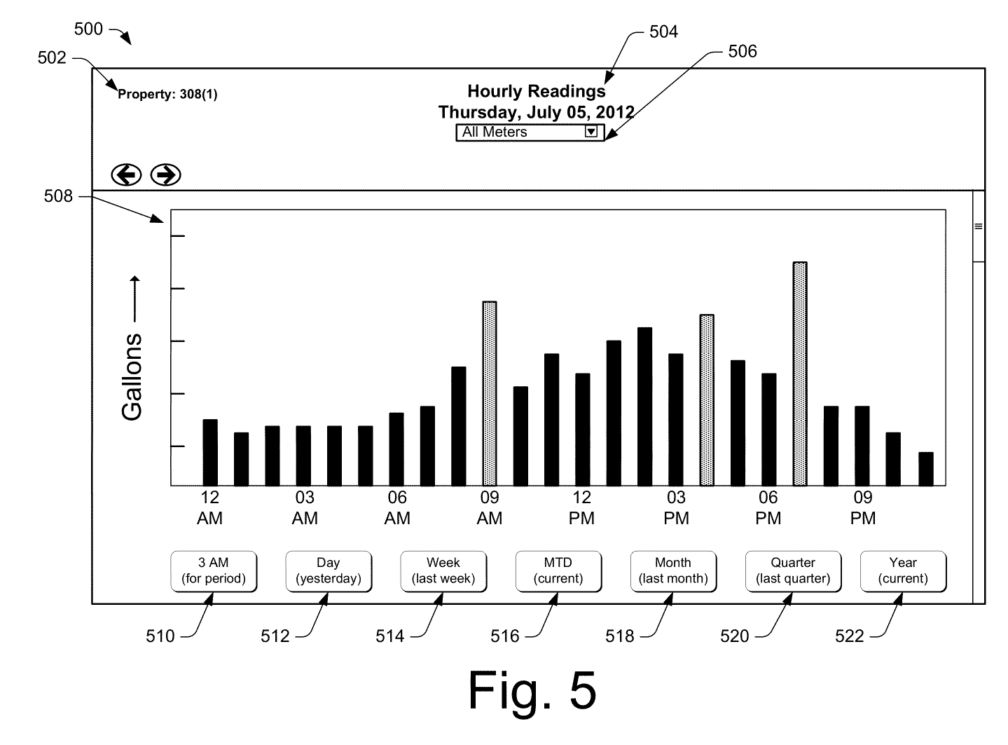

Referring now to FIG. 5, an example of a screen rendering of an interactive reports page 500 is illustrated relating to fluid flow data for presentation to an authorized user 134. In the case where there is an associated property, the associated property may be indicated in message pane 502 of the interactive reports page 500. In some embodiments, the interactive reports page 500 may be the page that the authorized user 134 was directed to upon selecting information presented in either of the dashboard user interface 300 of FIG. 3, or the alerts page 400 of FIG. 4. The interactive reports page 500 further includes a message pane 504 with identification text or other informative text relating to a report currently presented to the authorized user 134 including the time period over which the report was generated. The interactive reports page 500 may include a selection tool 506 for selecting a meter ID such that fluid flow information pertaining to the selected flow meter may be viewed in a report. The selection tool 506 may include an option to view fluid flow data for “all meters” associated with the authorized user 134, as shown in FIG. 5. The interactive reports page 500 includes a graph section 508 which presents fluid flow information for a property shown in message pane 502 over a given time period. For example, as shown in FIG. 5, hourly fluid flow information over the course of a day is presented in the graph section 508 in the form of a bar graph. It is to be appreciated that any suitable type of graphical representation of fluid flow information may be utilized for graph section 508, such as pie charts, line graphs, Venn diagrams, or any suitable type of graph to convey statistical information. FIG. 5 shows the hourly readings for fluid flow on property 308(1) for Thursday, Jul. 5, 2012, measured in gallons of fluid each hour. It is to be appreciated that other units of measurement may be used without changing the basic characteristics of the invention.

In some embodiments, time periods where alerts are generated may be so indicated in the graph section 508. For example, for readings at the times of 9:00 AM, 4:00 PM, and 7:00 PM for property 308(1), alert conditions were met, such as the alert conditions shown on alerts page 400 of FIG. 4. These alert conditions are indicated by different patterns or colors on the bars of the bar graph associated with the readings at those hours of the day. Other suitable techniques for indicating alert conditions on a graph may be used without changing the basic characteristics of the invention.

One way in which an authorized user 134 can interact with the interactive reports page 500 is by selecting one of a plurality of buttons 510-522 which are configured to generate reports in graphical form to convey fluid flow information over various time periods. Accordingly, the interactive reports page 500 may include a “3 AM” button 510 configured to generate a report showing fluid flow at the hour of 3:00 AM aver the course of a time period, a “Day” button 512 configured to generate a report showing fluid flow over the previous 24 hour period, a “Week” button 514 configured to generate a report showing fluid flow over the last week, a “MTD” button 516 configured to generate a report showing fluid flow over the current month up to the current date, a “Month” button 518 configured to generate a report showing fluid flow over the last month, a “Quarter” button 520 configured to generate a report showing fluid flow over the last quarter (i.e., three-month time period), and a “Year” button 522 configured to generate a report showing fluid flow over the last year. It is to be appreciated that other suitable time periods and data groupings can be utilized without changing the basic characteristics of the invention such that any suitable time period for viewing fluid flow information may be utilized to generate a report on the interactive reports page 500. By selecting any of the buttons 510-522, an authorized user 134 may cause to be displayed any type of report that is desired.

### Example Processes

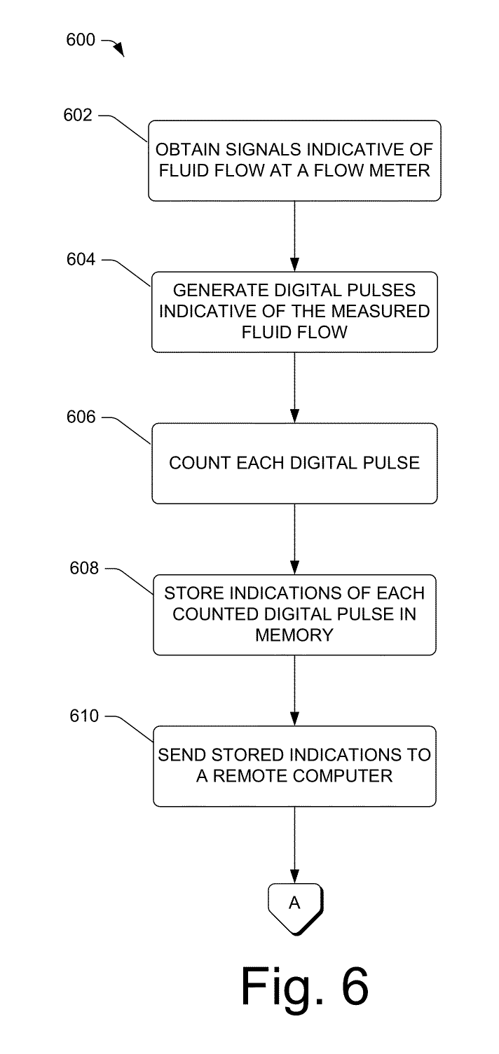

FIG. 6 is a flow diagram of an illustrative process 600 for continuously monitoring fluid flow at a fluid monitor and sending data pertaining to fluid flow to a remote computer for analysis and reporting. The process is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process.

For discussion purposes, the process 600 is described with reference to the architecture 100 of FIG. 1, and the subsystem of FIG. 2. In particular, many acts described below may be implemented and performed by the fluid monitoring subsystem 106, 200.

At 602, signals indicative of fluid flow at a fluid monitor, or flow meter, are obtained. In some embodiments, this may be accomplished via an intelligent sensor 108 which measures a magnetic field created by coupling magnets of a water meter to generate the signals. In this scenario, the intelligent sensor 108 may utilize the magnetic sensor 202 to measure the magnetic field created by the coupling magnets of a flow meter, and to output an analog signal based at least in part on the measurement. In yet other embodiments, signals indicative of the fluid flow at a fluid monitor may be output directly to the processing unit 110.

At 604, the signals obtained in 602 are utilized to generate a digital pulse indicative of a set amount of fluid that has flowed through a pipe at the fluid monitor. In some embodiments, this may be accomplished by receiving signals from the magnetic sensor 202 indicating that the coupling magnets have completed a revolution corresponding to a set amount of fluid that has flowed through the pipe. In yet other embodiments, if the fluid monitor 102 is configured to output the digital pulses and send them directly to the processing unit 110, step 604 may be unnecessary, and omitted accordingly.

At 606 each digital pulse generated at 604 is counted by a microcontroller in the processing unit 110, such as the microcontroller 216. At 608, each indication of a digital pulse counted at 606 is stored in memory of the processing unit 110. In some embodiments, each stored indication of a digital pulse may be associated with a time and date stamp. Other suitable data/information may be associated with each indication of a digital pulse, such as temperature data, and the like.

At 610, the stored indications of each counted digital pulse are sent to a remote computer(s) for subsequent processing and consumption. The stored indications may be sent individually, or in batch, and may be sent according to a predetermined schedule, such as once per day, or upon the pulse count exceeding a threshold level. Once the indications of each counted digital pulse are sent, they may be erased from the memory of the processing unit 110 to create room for data to be collected in the future.

In one illustrative embodiment, the intelligent sensor 108 measures a magnetic field at a water meter by utilizing the magnetic sensor 202. The intelligent sensor 108 generates a digital pulse indicative of a revolution of the coupling magnets in the water meter using the microcontroller 210 and sends the digital pulse to the processing unit 110. The processing unit 110 utilizes the microcontroller 216 to count each digital pulse, and the processing unit 110 stores each indication of the counted digital pulses in memory. The processing unit 110 sends the stored indications to the remote computer(s) 112 via the communication device 224.

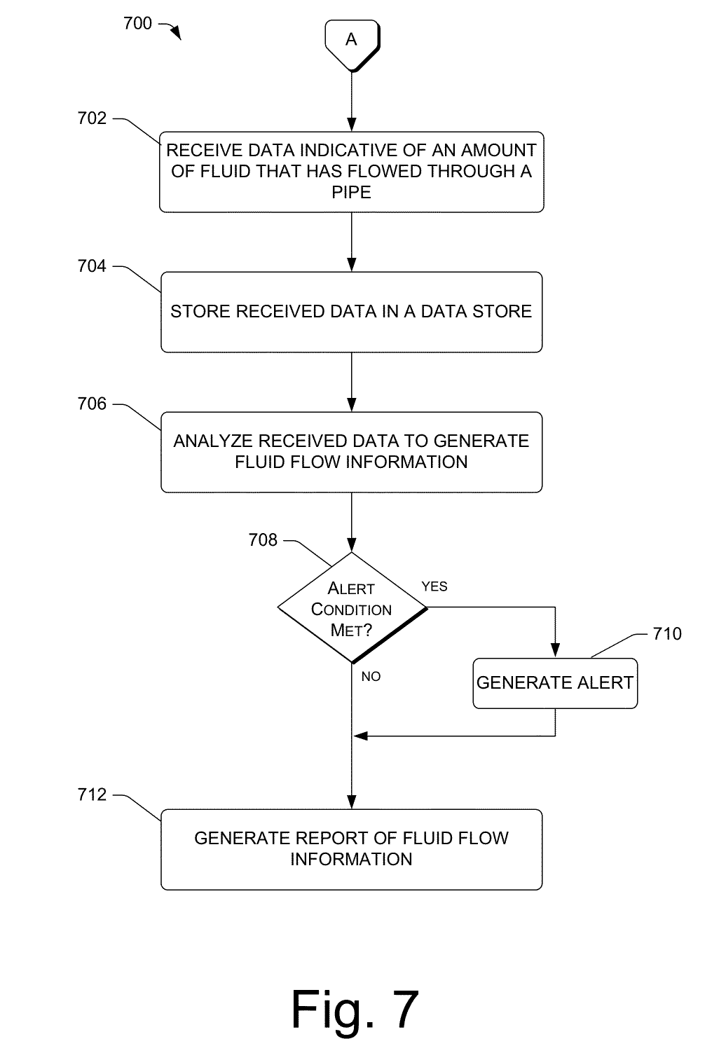

FIG. 7 is a flow diagram of an illustrative process 700 for receiving data pertaining to fluid flow, analyzing the received data and generating reports. The process 700 may continue from the process 600 from step 610 as is shown by the designation “A” in FIGS. 6 and 7. As discussed with reference to the process 600 in FIG. 6, the order in which the operations are described with reference to the process 700 is not intended to be construed as a limitation, and any number of the described blocks can be combined in any order and/or in parallel to implement the process 700. For discussion purposes, the process 700 is described with reference to the architecture 100 of FIG. 1, and the fluid monitoring subsystem of FIG. 2. In particular, many acts described below may be implemented and performed by the remote computer(s) 112 via the fluid monitoring engine 126.

At 702, data indicative of an amount of fluid that has flowed through a pipe (e.g., indications of digital pulses) is received from the fluid monitoring subsystem 106, 200 at the remote computer(s) 112. In some embodiments, the data received at 702 may be associated with additional data such as a time and date stamp, temperature data, a meter ID, and similar data.

At 704, the received data is stored in a data store, such as the data store 120, for subsequent processing/analysis. The stored data may be accessed at 706 by the analysis component 128 of the fluid monitoring engine 126 in order to analyze the accessed data for generating fluid flow information. For example, digital pulse data that is accessed in the data store 120 may be associated with a meter ID, and a date and time stamp so that the analysis component 128 may correlate fluid flow data to different times of the day and create information as to fluid flow over time based at least in part on the data received at 702 and stored at 704.

At 708, a determination is made by the alert component 130 as to whether an alert condition has been triggered. This may be done by comparing fluid flow information for a given time period to predetermined alert settings, such as threshold levels of fluid amounts. If criteria are met according to the predetermined alert settings, an alert condition may be triggered. For example, in embodiments pertaining to a water system, a predetermined alert setting may be based on a threshold water usage amount of 1,000 gallons per hour. If the alert component 130 determines at 708 that water usage data received from the analysis component 128 indicates that more than 1,000 gallons of water were used over the last hour, an alert condition may be triggered, and an alert may be generated at 710 following the “yes” route from 708 of FIG. 7. If, on the other hand, the alert component 130 does not detect that an alert condition has been met at 708, the “no” route is followed to 712 where a report is generated that displays, presents, or otherwise communicates fluid flow information, and possibly alerts, to an authorized user 134. The report is generated whether an alert is generated at 710 or not, the only difference being that, if an alert condition is met at 708, the report that is generated at 712 will include an indication of the alert generated at 710. It is to be appreciated that alerts generated at 710 may additionally, or alternatively, be provisioned in other ways, such as via email, SMS text messaging, and similar messaging techniques.

The environment and individual elements described herein may of course include many other logical, programmatic, and physical components, of which those shown in the accompanying figures are merely examples that are related to the discussion herein.

The various techniques described herein are assumed in the given examples to be implemented in the general context of computer-executable instructions or software, such as program modules, that are stored in computer-readable storage and executed by the processor(s) of one or more computers or other devices such as those illustrated in the figures. Generally, program modules include routines, programs, objects, components, data structures, etc., and define operating logic for performing particular tasks or implement particular abstract data types.

Other architectures may be used to implement the described functionality, and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A system for monitoring fluid flow within a pipe at a fluid monitor, comprising:
a processing unit configured to receive a plurality of digital pulses, each digital pulse indicative of a set amount of fluid that has flowed through the pipe, the processing unit comprising:
a microcontroller configured to count the plurality of digital pulses,
a memory configured to store data, the data comprising indications of each of the counted digital pulses, and
a communication device configured to transmit the data to a remote computing device.

2. The system of claim 1, the processing unit further comprising a temperature sensor configured to measure a temperature, wherein the data further comprises an indication of the temperature measured by the temperature sensor for each of the counted digital pulses.

3. The system of claim 1, wherein the data further comprises an indication of a date and a time for each of the counted digital pulses.

4. The system of claim 1, wherein the fluid is water, and wherein the fluid monitor is a water meter comprising coupling magnets, the system further comprising an intelligent sensor adjacent the fluid monitor, the intelligent sensor comprising:
a magnetic sensor configured to sense a magnetic field created by the coupling magnets in order to generate signals indicative of the fluid flow within the pipe; and
a second microcontroller configured to receive the signals and to output the plurality of digital pulses, wherein each digital pulse is indicative of a revolution of the coupling magnets.

5. The system of claim 4, the intelligent sensor further comprising a power switch, wherein the microcontroller is configured to switch off power to the magnetic sensor using the power switch between instances of sensing the magnetic field.

6. The system of claim 4, further comprising a cable connecting the intelligent sensor and the processing unit, the processing unit further comprising a power source, wherein the cable is further configured to provide power from the power source to the intelligent sensor.

7. The system of claim 1, wherein the communication device is further configured to transmit the data according to a predetermined schedule.

8. The system of claim 1, wherein the communication device is further configured to transmit the data in response to a number of the counted digital pulses exceeding a threshold number.

9. A computer-implemented method, comprising:
receiving data indicative of an amount of fluid that has flowed through a pipe associated with a fluid monitor;
storing the received data in a memory;
analyzing, by one or more processors, at least a portion of the received data to generate fluid flow information, the fluid flow information relating to an amount of fluid that has flowed through the pipe over a period of time at a location of the fluid monitor;
comparing the fluid flow information to a criterion;
generating an alert when the criterion is satisfied; and
provisioning the alert to a user.

10. The method of claim 9, wherein the criterion is satisfied when the amount of fluid that has flowed through the pipe over the period of time exceeds a threshold amount of fluid.

11. The method of claim 10, further comprising generating a plurality of alerts when the criterion is satisfied, and wherein each of the plurality of alerts is assigned a score based at least in part on a difference between the amount of fluid that has flowed through the pipe over the period of time and the threshold amount of fluid.

12. The method of claim 11, further comprising ranking the plurality of alerts based on the score for each of the plurality of alerts.

13. The method of claim 9, wherein the fluid monitor is a water meter, and wherein the criterion is satisfied when (i) the amount of fluid that has flowed through the pipe over the period of time exceeds a threshold amount of fluid and (ii) a number of occupied units of a property at the location is below a threshold number of occupied units.

14. The method of claim 9, wherein the alert is provisioned via at least one of an email, a short message service (SMS) text message, or a social networking message.

15. The method of claim 9, further comprising issuing a recommendation to the user for addressing the alert.

16. The method of claim 9, wherein the data is received according to a predetermined schedule.

17. One or more non-transitory computer-readable media storing computer-executable instructions that, when executed on one or more processors, performs acts comprising:
receiving data indicative of an amount of fluid that has flowed through a pipe associated with a fluid monitor;
storing the received data in a data store;
analyzing at least a portion of the received data to generate fluid flow information, the fluid flow information relating to an amount of fluid that has flowed through the pipe over a period of time at a location of the fluid monitor;
generating an alert when a criterion is satisfied based at least in part on the fluid flow information; and
generating a report based at least in part on the fluid flow information, the report including the alert.

18. The one or more non-transitory computer-readable media as recited in claim 17, wherein the data is received according to a predetermined schedule.

19. The one or more non-transitory computer-readable media as recited in claim 18, further comprising sending information to a processing unit to update the predetermined schedule.

20. The one or more non-transitory computer-readable media as recited in claim 17, further comprising presenting the report via a graphical user interface.

21. A system for monitoring fluid flow within a pipe at a fluid monitor, comprising:
means for receiving a plurality of digital pulses, each digital pulse indicative of a set amount of fluid that has flowed through the pipe, the means for receiving comprising:
means for counting the plurality of digital pulses,
means for storing data, the data comprising indications of each of the counted digital pulses, and
means for transmitting the data to a remote computing device.

22. The system of claim 21, wherein the fluid is water, and wherein the fluid monitor is a water meter comprising coupling magnets, the system further comprising:
means for generating signals indicative of the fluid flow within the pipe based on sensing a magnetic field created by the coupling magnets; and
means for outputting the plurality of digital pulses in response to receiving the signals, wherein each digital pulse is indicative of a revolution of the coupling magnets.

23. The system of claim 21, wherein the means for transmitting is further configured to transmit the data in response to a number of the counted digital pulses exceeding a threshold number.
